(19) United States
(12) Patent Application Publication
(10) Pub. No.: US 2024/0140376 A1
(43) Pub. Date: May 2, 2024

(54) DEVICE FOR CONTROLLING BRAKING OF VEHICLE

(71) Applicant: ADVICS CO., LTD., Kariya-shi, Aichi-ken (JP)

(72) Inventor: Yusaku YAMAMOTO, Kariya-shi, Aichi-ken (JP)

(73) Assignee: ADVICS CO., LTD., Kariya-shi, Aichi-ken (JP)

(21) Appl. No.: 18/546,683

(22) PCT Filed: Mar. 30, 2022
(86) PCT No.: PCT/JP2022/016164

§ 371 Date: Aug. 16, 2023

(30) Foreign Application Priority Data
Mar. 30, 2021 (JP) 2021-057389

(51) Int. Cl. B60T 8/1755

(52) U.S. Cl. CPC B60T 8/17555; B60T 2230/04

(57) ABSTRACT

A braking control device includes a control unit that controls a braking force in accordance with an operation amount of a braking operation member, and a braking determination unit that determines whether or not a reduction in the operation amount of the braking operation member has been started when the braking force is applied to a vehicle due to the operation of the braking operation member. In a case where a reduction rate of the operation amount upon determination that the reduction in the operation amount has been started is equal to or larger than a reduction rate determination value, the control unit starts limitation processing of providing a limitation to the reduction rate of the braking force against the vehicle.

### TECHNICAL FIELD

The disclosure here relates to a device for controlling braking of a vehicle.

### BACKGROUND ART

Patent Literature 1 describes an example of acceleration/deceleration control of a vehicle when the vehicle is automatically traveling. That is, when deceleration of the vehicle is required in a state where the vehicle is accelerating, a predetermined interval time is provided between when deceleration is required and when deceleration of the vehicle is started. As a result, a vehicle behavior in the case where the automatically traveling vehicle shifts from the acceleration state to the deceleration state of the vehicle can be brought close to the vehicle behavior in the case where the vehicle is caused to travel by the manual operation of a driver.

### CITATIONS LIST

### Patent Literature

Patent Literature 1: JP 2017-121851 A

### SUMMARY

### Technical Problems

When the operation of the braking operation member by the driver is canceled in a situation where the vehicle is decelerated due to the operation of the braking operation member by the driver, the braking force is not applied to the vehicle, and thus the pitch angle of the vehicle changes. At this time, when the change rate of the pitch angle is large, a passenger of the vehicle may feel uncomfortable.

### Solutions to Problems

A device for controlling braking of a vehicle for solving the above problem is a device that controls a braking force against a vehicle due to an operation of a braking device. The braking control device includes a control unit that controls a braking force against the vehicle in accordance with an operation amount of a braking operation member, and a braking determination unit that determines whether or not a reduction in the operation amount has been started when the braking force is applied to the vehicle due to operation of the braking operation member. When a reduction rate of the operation amount upon determination that the reduction in the operation amount has been started is equal to or larger than a reduction rate determination value, the control unit starts limitation processing of limiting the reduction rate of the braking force against the vehicle.

When the operation amount of the braking operation member is reduced in a situation where the braking force is applied to the vehicle due to the operation of the braking operation member by the driver, the braking force is also reduced. When the braking force is reduced, the pitch angle of the vehicle body of the vehicle is changed. With the above configuration, when the reduction rate of the operation amount upon determination that the reduction in the operation amount has been started is equal to or larger than the reduction rate determination value, the limitation processing is executed. In the limitation processing, a limitation is set on the reduction rate in the braking force. Therefore, during the execution of the limitation processing, the braking force is reduced, but the reduction rate in the braking force does not become too large. As a result, although the pitch angle is changed in accordance with the reduction in the braking force, it is possible to prevent an increase in the change rate of the pitch angle.

When the reduction rate of the operation amount upon determination that the reduction in the operation amount has been started is less than the reduction rate determination value, even when the braking force is reduced at a rate corresponding to the reduction rate of the operation amount, the reduction rate of the braking force does not become large in the first place. Therefore, even when the pitch angle is changed in accordance the reduction in the braking force, the change rate of the pitch angle does not increase much.

Therefore, with the above configuration, it is possible to prevent the passenger from feeling uncomfortable when the operation amount of the braking operation member is reduced by the driver.

### BRIEF DESCRIPTION OF DRAWINGS

FIG. 1 is a diagram showing a functional configuration of a device for controlling braking of a vehicle of a first embodiment and an outline of a vehicle to which the braking control device is applied.

FIG. 2 is a flowchart for explaining a processing routine executed by the braking control device.

FIGS. 3(a) and 3(b) are timing charts when the operation of the braking operation member by the driver is canceled.

FIGS. 4(a) and 4(b) are timing charts when the operation of the braking operation member by the driver is canceled in a braking control device of a second embodiment.

FIG. 5 is a map showing a relationship between a reduction rate instruction value and a longitudinal acceleration of a vehicle in a braking control device of a third embodiment.

FIGS. 6(a) and 6(b) are timing charts when the operation of the braking operation member by the driver is canceled in the braking control device of the third embodiment.

FIG. 7 is a flowchart for explaining a part of a processing routine executed by a braking control device of a fourth embodiment.

FIGS. 8(a) and 8(b) are timing charts when the operation of the braking operation member by the driver is canceled in the braking control device of the fourth embodiment.

FIGS. 9(a) to 9(d) are timing charts when the operation of the braking operation member by the driver is canceled in a braking control device of a fifth embodiment.

FIG. 10 is a schematic view illustrating a positional relationship between the head of a passenger and a headrest of the vehicle in the braking control device.

FIG. 11 is a schematic view illustrating a positional relationship between the head of a passenger and a headrest in the braking control device.

FIG. 12 is a schematic view illustrating a positional relationship between the head of a passenger and a headrest in the braking control device.

FIG. 13 is a schematic view illustrating a positional relationship between the head of a passenger and a headrest in the braking control device.

### DESCRIPTION OF EMBODIMENTS

### First Embodiment

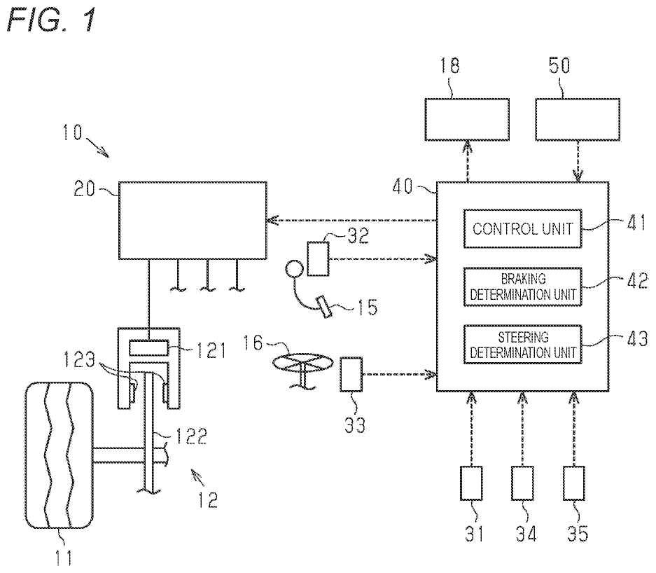

Hereinafter, a first embodiment of a device for controlling braking of a vehicle will be described with reference to FIGS. 1 to 3.

### <Overall Configuration>

FIG. 1 schematically illustrates a part of a vehicle 10 including a braking control device 40 of the present embodiment. The vehicle 10 includes a braking device 20 controlled by the braking control device 40 and the same number of braking mechanisms 12 as wheels 11. Each braking mechanism 12 operates to generate a braking force on the corresponding wheel 11. The braking mechanism 12 includes a wheel cylinder 121, a rotating body 122 that rotates integrally with the wheel 11, and a friction material 123. The higher the wheel pressure, which is the hydraulic pressure in the wheel cylinder 121, the larger the pressing force, which is the force of pressing the friction material 123 against the rotating body 122. The braking force generated by the wheel 11 increases as the pressing force increases.

The braking device 20 controls the braking force generated at each wheel 11 by adjusting the wheel pressure of each wheel cylinder 121. That is, the braking device 20 adjusts the braking force BP against the vehicle 10 by controlling the braking force generated by each wheel 11. The sum of the braking forces generated at the wheels 11 is the braking force BP against the vehicle 10.

When the driver of the vehicle 10 operates the braking operation member 15, the braking device 20 operates in accordance with an instruction from the braking control device 40. Examples of the braking operation member 15 include a brake pedal. When the braking control device 40 instructs to increase the braking force BP, such as when the operation amount of the braking operation member 15 increases, the braking device 20 operates to increase the wheel pressure of each wheel cylinder 121. On the other hand, when the braking control device 40 instructs to reduce the braking force BP, such as when the operation amount of the braking operation member 15 is reduced, the braking device 20 operates to reduce the wheel pressure of each wheel cylinder 121.

The driver is an occupant seated on the driver's seat. An occupant seated on a seat other than the driver's seat is referred to as a passenger. The seats other than the driver's seat are, for example, a passenger seat and a rear seat.

A braking lamp 18 is provided at a rear portion of the vehicle body in the vehicle 10. The braking lamp 18 is controlled by the braking control device 40. For example, when the braking force BP is applied to the vehicle 10, the braking lamp 18 is turned on. On the other hand, when the braking force BP is not applied to the vehicle 10, the braking lamp 18 is turned off.

### <Detection System of Vehicle 10>

The vehicle 10 includes various sensors. Examples of the sensors include a wheel speed sensor 31, a braking operation amount sensor 32, a steering angle sensor 33, a longitudinal acceleration sensor 34, a lateral acceleration sensor 35, and the like. Each of these sensors 31 to 35 outputs a signal corresponding to the detection result to the braking control device 40 as a detection signal.

The vehicle 10 is provided with the same number of wheel speed sensors 31 as the number of wheels 11. The wheel speed sensor 31 detects a wheel speed VW, which is a rotation speed of the corresponding wheel 11. The braking operation amount sensor 32 detects an operation amount X of the braking operation member 15 by the driver. The steering angle sensor 33 detects a steering angle STR of the steering wheel 16 operated by the driver. The longitudinal acceleration sensor 34 detects a longitudinal acceleration Gx of the vehicle 10. The lateral acceleration sensor 35 detects a lateral acceleration Gy of the vehicle 10.

The vehicle 10 includes a monitoring system 50 that monitors the surroundings of the vehicle 10. The monitoring system 50 includes an imaging unit such as a camera, a radar, and the like. The monitoring system 50 monitors, for example, a position of another vehicle around the vehicle 10, a position of a pedestrian, and a signal. The monitoring system 50 outputs information related to a monitoring result of the monitoring system 50 to the braking control device 40.

<Braking control device 40>

The braking control device 40 includes a CPU and a storage device. The storage device stores a program executed by the CPU. That is, when the CPU executes the program, the braking control device 40 can execute various processes related to braking.

The braking control device 40 includes a control unit 41 and a braking determination unit 42 as functional units.

The control unit 41 controls the braking force BP of the vehicle 10 in accordance with the operation amount X of the braking operation member 15. For example, the control unit 41 derives a larger value as the operation amount X increases as a required braking force BPr. The required braking force BPr is a required value of the braking force BP. The control unit 41 derives an instruction braking force BPTr, which is an instruction value of the braking force BP on the basis of the required braking force BPr. Then, the control unit 41 operates the braking device 20 on the basis of the instruction braking force BPTr. Accordingly, when the operation amount X is increased, the braking force BP can be increased. When the operation amount X is reduced, the braking force BP can be reduced.

When the braking force BP is applied to the vehicle 10 due to operation of the braking operation member 15, the braking determination unit 42 determines whether or not the reduction in the operation amount X has been started.

The braking control device 40 includes a steering determination unit 43. The steering determination unit 43 determines whether or not the driver has started operating the steering wheel 16, that is, steering. In addition, the steering determination unit 43 may determine whether or not the start of steering was able to be predicted. In the present embodiment, the braking control device 40 may not include the steering determination unit 43.

<Flow of Processing Executed by Braking Control Device 40 when Operation of Braking Operation Member 15 by Driver is Canceled>

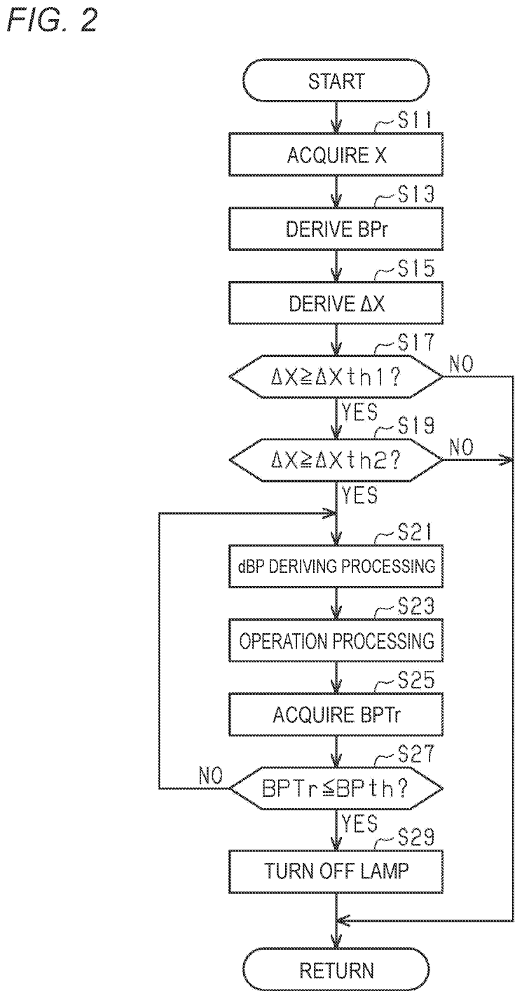

A processing routine executed by the braking control device 40 when the operation of the braking operation member 15 is canceled will be described with reference to FIG. 2. The braking control device 40 repeatedly executes the present processing routine when the braking force BP is applied to the vehicle 10 due to the operation of the braking operation member 15 by the driver.

In the present processing routine, in the first step S11, the braking control device 40 acquires the operation amount X of the braking operation member 15. In the next step S13, the braking control device 40 derives the required braking force BPr on the basis of the operation amount X.

Subsequently, in step S15, the braking control device 40 derives a reduction rate ΔX of the operation amount X. For example, the braking control device 40 derives a product of a value obtained by time-differentiating the operation amount X and “−1” as the reduction rate ΔX. In this case, when the operation amount X increases, a negative value is derived as the reduction rate ΔX. On the other hand, when the operation amount X is reduced, a positive value is derived as the reduction rate ΔX.

In the next step S17, the braking determination unit 42 of the braking control device 40 determines whether or not the reduction rate ΔX is equal to or larger than a first determination reduction rate ΔXth1. The first determination reduction rate ΔXth1 is a criterion for determining, on the basis of the reduction rate ΔX, whether or not the operation amount X is reduced. For example, a positive value is set as the first determination reduction rate ΔXth1. When the reduction rate ΔX is equal to or larger than the first determination reduction rate ΔXth1, it is regarded that the operation amount X is reduced due to the operation of the braking operation member 15 by the driver. On the other hand, when the reduction rate ΔX is smaller than the first determination reduction rate ΔXth1, it is not regarded that the operation amount X is reduced.

When the reduction rate ΔX is smaller than the first determination reduction rate ΔXth1 (S17: NO), the braking control device 40 temporarily ends the present processing routine. In this case, the control unit 41 of the braking control device 40 sets a value equal to the required braking force BPr as the instruction braking force BPTr, and operates the braking device 20 on the basis of the instruction braking force BPTr.

On the other hand, in step S17, when the reduction rate ΔX is equal to or larger than the first determination reduction rate ΔXth1 (YES), the braking control device 40 proceeds the processing to step S19. In step S19, the braking control device 40 determines whether or not the reduction rate ΔX is equal to or larger than a second determination reduction rate ΔXth2. The second determination reduction rate ΔXth2 is a criterion for determining whether or not the driver operates the braking operation member 15 in a manner so as to gradually reduce the operation amount X. A value larger than the first determination reduction rate ΔXth1 is set as the second determination reduction rate ΔXth2. When the reduction rate ΔX is smaller than the second determination reduction rate ΔXth2, it is regarded that the driver operates the braking operation member 15 in a manner so as to gradually reduce the operation amount X. On the other hand, when the reduction rate ΔX is equal to or larger than the second determination reduction rate ΔXth2, it is not regarded that the driver operates the braking operation member 15 in a manner so as to gradually reduce the operation amount X. That is, the second determination reduction rate ΔXth2 corresponds to the “reduction rate determination value”. Therefore, it can be said that, in step S19, determination is made as to whether or not the reduction rate of the operation amount X upon determination that the reduction in the operation amount X has been started is equal to or larger than the reduction rate determination value.

In step S19, when the reduction rate ΔX is smaller than the second determination reduction rate ΔXth2 (NO), the braking control device 40 temporarily ends the present processing routine. In this case, the braking control device 40 sets a value equal to the required braking force BPr as the instruction braking force BPTr, and operates the braking device 20 on the basis of the instruction braking force BPTr.

On the other hand, in step S19, when the reduction rate ΔX is equal to or larger than the second determination reduction rate ΔXth2 (YES), the control unit 41 of the braking control device 40 executes the limitation processing of limiting the reduction rate of the braking force BP. That is, when the reduction rate of the operation amount X upon determination that the reduction in the operation amount X has been started is equal to or larger than the reduction rate determination value, the control unit 41 starts the limitation processing.

In the limitation processing, in step S21, the control unit 41 executes deriving processing of deriving a reduction rate instruction value dBP that is an instruction value of the reduction rate of the braking force BP. Here, in order to reduce the braking force BP, a positive value is derived as the reduction rate instruction value dBP. In the present embodiment, the control unit 41 sets a limited reduction rate dBPL as the reduction rate instruction value dBP. For example, the reduction rate of the required braking force BPr when the reduction rate ΔX of the operation amount X is equal to the second determination reduction rate ΔXth2 is set as the limited reduction rate dBPL. Upon deriving the reduction rate instruction value dBP, the control unit 41 proceeds the processing to step S23.

In step S23, the control unit 41 executes operation processing of operating the braking device 20. That is, the control unit 41 derives the product of the reduction rate instruction value dBP and a cycle time as the instruction reduction amount ΔBP. The cycle time is a time corresponding to an execution interval of the operation processing when the operation processing is repeatedly executed during the execution of the limitation processing. The control unit 41 derives a value obtained by subtracting the instruction reduction amount ΔBP from a previous value BPTr1 of the instruction braking force BPTr as the latest instruction braking force BPTr. The previous value BPTr1 of the instruction braking force is the instruction braking force BPTr derived when the operation processing of step S23 is executed last time. When the processing of step S23 is executed for the first time after it has been determined that the reduction in the operation amount X has been started, the braking force BP at that time is set as the previous value BPTr1 of the instruction braking force. As a result, the instruction braking force BPTr can be reduced at a rate corresponding to the reduction rate instruction value dBP.

Subsequently, in the operation processing, the control unit 41 operates the braking device 20 on the basis of the instruction braking force BPTr. In the present embodiment, steps S21 and S23 correspond to “limitation processing”. When the control unit 41 operates the braking device 20 through the execution of the limitation processing, the braking control device 40 proceeds the processing to step S25.

In step S25, the braking control device 40 acquires the instruction braking force BPTr. In the next step S27, the braking control device 40 determines whether or not the instruction braking force BPTr acquired in step S25 is equal to or less than a cancellation determination value BPth. The cancellation determination value BPth is a criterion for determining whether or not the braking force BP is still applied to the vehicle 10. For example, 0 is set as the cancellation determination value BPth. When the instruction braking force BPTr is equal to or less than the cancellation determination value BPth, it is regarded that the braking force BP is not applied to the vehicle 10. On the other hand, when the instruction braking force BPTr is larger than the cancellation determination value BPth, it is regarded that the braking force BP is still applied to the vehicle 10.

In step S27, when the instruction braking force BPTr is larger than the cancellation determination value BPth (NO), the braking control device 40 proceeds the processing to step S21. That is, the control unit 41 of the braking control device 40 continues the limitation processing. On the other hand, in step S27, when the instruction braking force BPTr is equal to or less than the cancellation determination value BPth (YES), the braking control device 40 proceeds the processing to step S29. That is, the control unit 41 ends the limitation processing. Then, in step S29, the braking control device 40 turns off the braking lamp 18. Thereafter, the braking control device 40 temporarily ends the present processing routine.

### Operation and Effects of Present Embodiment

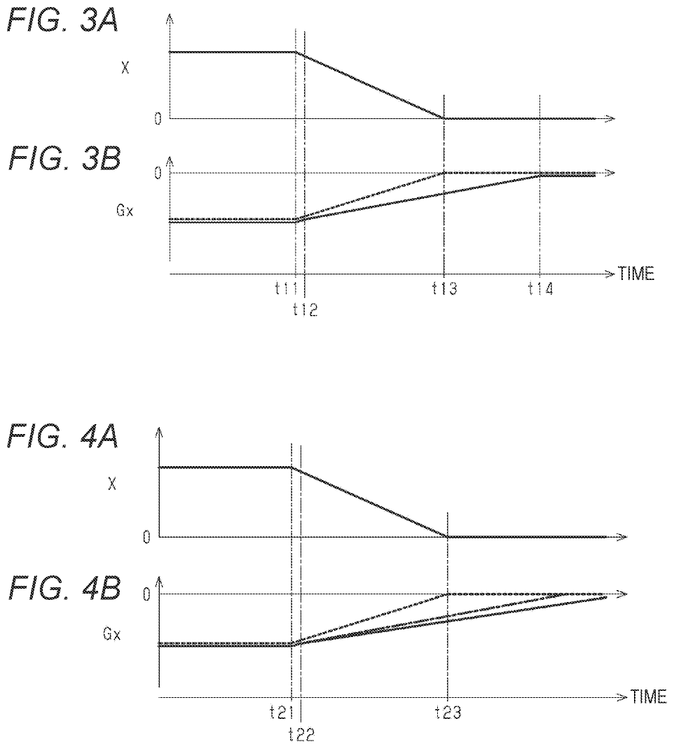

FIG. 3 illustrates the transition of the operation amount X and the transition of the longitudinal acceleration Gx when the operation of the braking operation member 15 by the driver is canceled.

As illustrated in FIGS. 3(a) and 3(b), when the driver operates the braking operation member 15, the braking force BP of the vehicle 10 increases as the operation amount X increases, and thus the longitudinal acceleration Gx of the vehicle 10 is reduced. The operation amount X starts to reduce from timing tn. Then, at timing t12, it is determined that the reduction in the operation amount X has been started.

In the period from timing t11 to timing t12, the braking force BP is reduced at a rate corresponding to the reduction rate of the operation amount X. That is, even when the operation amount X starts to be reduced, the braking force BP is reduced at the reduction rate of the required braking force BPr until it is determined that the reduction in the operation amount X has been started.

In FIG. 3(b), a change in the longitudinal acceleration Gx in a case where the limitation processing is not executed is indicated by a broken line. That is, it can be said that the change in the required braking force BPr is indicated by the broken line. On the other hand, a change in the longitudinal acceleration Gx in the present embodiment in which the limitation processing is executed is indicated by a solid line.

When the reduction rate ΔX of the operation amount is equal to or larger than the second determination reduction rate ΔXth2 at timing t12, the limitation processing is started. That is, when the reduction rate of the operation amount X upon determination that the reduction in the operation amount X has been started is equal to or larger than the reduction rate determination value, the limitation processing is started. In the limitation processing, a limitation is set on the reduction rate in the braking force BP. Therefore, in a case where the limitation processing is executed, the reduction rate of the braking force BP becomes smaller than that in the case where the limitation processing is not executed. In other words, the limitation here is to reduce the braking force BP, but to prevent the reduction rate of the braking force BP from becoming larger.

In the present embodiment, the braking force BP is reduced in accordance with the reduction rate instruction value dBP. The reduction rate instruction value dBP is smaller than the reduction rate of the required braking force BPr. That is, a smaller one of the limited reduction rate dBPL and the reduction rate of the required braking force BPr is set as the reduction rate instruction value dBP. As a result, the increase rate of the longitudinal acceleration Gx is smaller than that in the case where the limitation processing is not executed.

At timing t13, the operation of the braking operation member 15 by the driver is canceled. For example, the required braking force BPr becomes 0. However, at timing t13, the braking force BP is still applied to the vehicle 10. Therefore, the reduction in the braking force BP in accordance with the reduction rate instruction value dBP is continued even after timing t13. At the subsequent timing t14, the instruction braking force BPTr becomes equal to or less than the cancellation determination value BPth, and the braking force BP is not applied to the vehicle 10. Then, the limitation processing is ended. Further, the braking lamp 18 is turned off.

When the operation amount X of the braking operation member 15 is reduced, the braking force BP is also reduced. When the braking force BP is reduced, the inertial force acting on the vehicle body of the vehicle 10 is reduced. As a result, the pitch angle of the vehicle body changes. When the change rate of the pitch angle is large, a passenger of the vehicle 10 may feel uncomfortable.

In this regard, in the present embodiment, when the reduction rate of the braking force BP upon determination that the reduction in the operation amount X has been started is equal to or larger than the reduction rate determination value, the limitation processing is executed. When the limitation processing is executed, the braking force BP is reduced, but the reduction rate of the braking force BP does not increase much. As a result, the inertial force acting on the vehicle body is slowly reduced. As a result, although the pitch angle is changed in accordance with the reduction in the braking force BP, it is possible to prevent an increase in the change rate of the pitch angle.

When the reduction rate of the braking force upon determination that the reduction in the operation amount X has been started is less than the reduction rate determination value, the limitation processing is not executed. That is, the braking force BP is reduced at a rate corresponding to the reduction rate of the operation amount X. In this case, even when the braking force BP is reduced at a rate corresponding to the reduction rate of the operation amount X, the reduction rate of the braking force BP is not large in the first place. Therefore, even when the limitation processing is not executed, the change rate of the pitch angle does not increase much.

Therefore, in the present embodiment, it is possible to prevent the passenger from feeling uncomfortable when the operation amount X of the braking operation member 15 is reduced by the driver.

Here, when the braking force BP is increased, in consideration of the comfort of the passenger, there are relatively many drivers who operate the braking operation member 15 in a manner as to slowly increase the operation amount X. However, when the braking force BP is reduced, few drivers operate the braking operation member 15 in a manner so as to slowly reduce the operation amount X in consideration of the comfort of the passenger.

In the present embodiment, it is possible to prevent an increase in the reduction rate of the braking force BP by executing the limitation processing when the operation amount X is reduced. That is, even in a case where the driver is less conscious of the comfort of the passenger upon reducing the braking force BP, it is possible to prevent a decrease in the comfort of the passenger.

### Second Embodiment

A second embodiment of a device for controlling braking of a vehicle will be described with reference to FIG. 4. In the following description, portions different from those of the first embodiment will be mainly described, and the same reference signs will be given to the same or corresponding member configurations as those of the first embodiment, and redundant description will be omitted.

In the present embodiment, the content of the processing in step S21 in FIG. 2 is different from that of the first embodiment. That is, in step S21, the control unit 41 reduces the reduction rate instruction value dBP of the braking force BP as a vehicle body speed VS of the vehicle 10 upon determination that the reduction in the operation amount X of the braking operation member 15 has been started is smaller.

For example, the braking control device 40 derives the vehicle body speed VS on the basis of a wheel speed VW of each wheel 11. When the vehicle body speed VS upon determination that the reduction in the operation amount X has been started is set as a reduction starting vehicle body speed VS1, the control unit 41 derives, as a correction gain al, a smaller value as the reduction starting vehicle body speed VS1 is smaller. In this case, a positive value smaller than 1 may be derived as the correction gain al. The control unit 41 derives a product of the limited reduction rate dBPL and the correction gain al as the reduction rate instruction value dBP. As a result, the reduction rate instruction value dBP can be made smaller as the vehicle body speed VS is smaller.

Subsequent to the deriving of the reduction rate instruction value dBP in step S21, the control unit 41 proceeds the processing to step S23. Since the content of each processing after step S23 is similar to that of the first embodiment, the description thereof is omitted.

### Operation and Effects of Present Embodiment

As illustrated in FIGS. 4(a) and 4(b), when the operation amount X starts to be reduced from timing t21, at timing t22, it is determined that the reduction in the operation amount X has been started.

In FIG. 4(b), a change in the longitudinal acceleration Gx in a case where the limitation processing is not executed is indicated by a broken line. On the other hand, a change in the longitudinal acceleration Gx in the present embodiment in which the limitation processing is executed is indicated by a solid line and an alternate long and short dash line.

When the reduction rate ΔX of the operation amount is equal to or larger than the second determination reduction rate ΔXth2 at timing t22, the limitation processing is started. In a case where the limitation processing is executed, the reduction rate of the braking force BP becomes smaller than that in the case where the limitation processing is not executed.

In the present embodiment, the reduction rate instruction value dBP is set based on the reduction starting vehicle body speed VS1, which is the vehicle body speed VS at timing t22. That is, as the reduction starting vehicle body speed VS1 is smaller, a smaller value is derived as the reduction rate instruction value dBP. Therefore, the braking force BP is gradually reduced as the reduction starting vehicle body speed VS1 is smaller. In FIG. 4(b), the alternate long and short dash line indicates a change in the longitudinal acceleration Gx when the reduction starting vehicle body speed VS1 is relatively large, and the solid line indicates a change in the longitudinal acceleration Gx when the reduction starting vehicle body speed VS1 is relatively small.

Here, in a case where the operation of the braking operation member 15 by the driver is canceled in a state where the vehicle body speed VS is relatively large, when the deviation between the change in the longitudinal acceleration in accordance with the reduction rate of the operation amount X and the change in the actual longitudinal acceleration Gx is large, the driver may feel uncomfortable about the vehicle behavior.

In this regard, in the present embodiment, when the operation of the braking operation member 15 by the driver is canceled in a state where the vehicle body speed VS is relatively large, the reduction rate of the braking force BP is prevented from becoming too small. As a result, even when the limitation processing is executed, the deviation between the change in the longitudinal acceleration in accordance with the reduction rate of the operation amount X and the change in the actual longitudinal acceleration Gx can be made less likely to increase. Therefore, when the operation amount X of the braking operation member 15 by the driver is reduced, it is possible to achieve both of the state that the passenger is less likely to feel uncomfortable and the state that the driver is less likely to feel uncomfortable about the vehicle behavior.

On the other hand, when the operation of the braking operation member 15 is canceled in a state where the vehicle body speed VS is relatively small, such as when the vehicle 10 comes to a stop, the braking force BP is gradually reduced. As a result, when the operation of the braking operation member 15 is canceled, the change in the pitch angle can be made gentler. Therefore, it is possible to further prevent a decrease in the comfort of the passenger when the operation amount X of the braking operation member 15 by the driver is reduced.

In the example illustrated in FIG. 4, the operation of the braking operation member 15 by the driver is canceled at timing t23. At timing t23, the instruction braking force BPTr is larger than the cancellation determination value BPth, and the braking force BP is still applied to the vehicle 10. Therefore, the limitation processing is continued even after timing t23.

### Third Embodiment

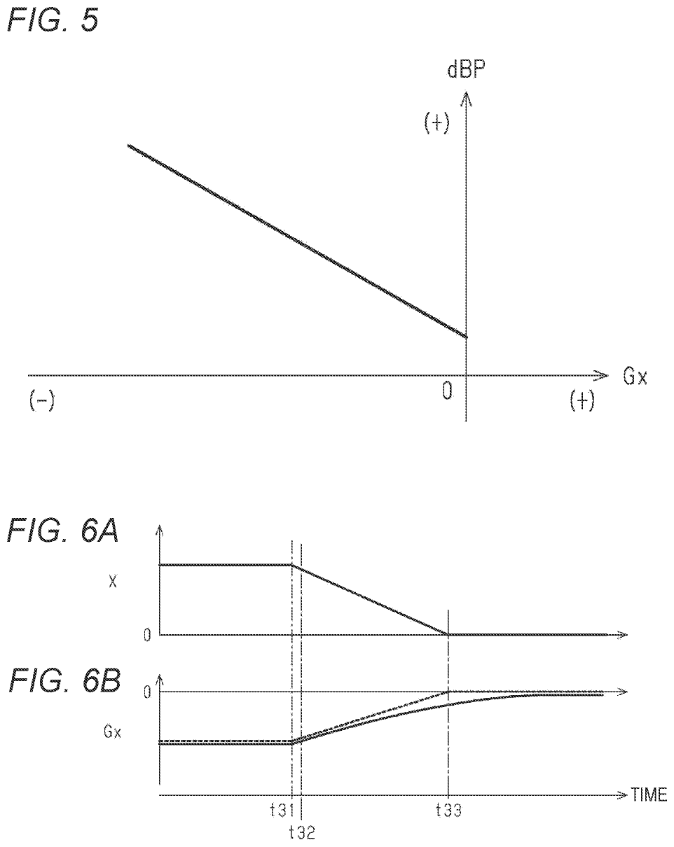

A third embodiment of a device for controlling braking of a vehicle will be described with reference to FIGS. 5 and 6. In the following description, portions different from those of the above-described embodiments will be mainly described, and the same reference signs will be given to the same or corresponding member configurations as those of the above-described embodiments, and redundant description will be omitted.

In the present embodiment, the content of the processing in step S21 in FIG. 2 is different from those of the above-described embodiments. That is, in step S21, the control unit 41 reduces the reduction rate instruction value dBP of the braking force BP as the longitudinal acceleration Gx increases.

For example, the control unit 41 derives the reduction rate instruction value dBP using the map illustrated in FIG. 5. The map is a map indicating the relationship between the longitudinal acceleration Gx and the reduction rate instruction value dBP. In the map, when the longitudinal acceleration Gx is a negative value, the reduction rate instruction value dBP increases as the absolute value of the longitudinal acceleration Gx increases. However, the upper limit of the reduction rate instruction value dBP is preferably equal to or less than the limited reduction rate dBPL.

Subsequent to the deriving of the reduction rate instruction value dBP in step S21, the control unit 41 proceeds the processing to step S23. Then, in step S23, the control unit 41 executes operation processing. When the instruction braking force BPTr is larger than the cancellation determination value BPth in subsequent step S27 (NO), the control unit 41 continues the limitation processing. In the present embodiment, when the longitudinal acceleration Gx changes due to the reduction in the operation amount X, the reduction rate instruction value dBP derived in step S21 changes. That is, the reduction rate instruction value dBP is reduced during the execution of the limitation processing.

### Operation and Effects of Present Embodiment

As illustrated in FIGS. 6(a) and 6(b), when the operation amount X starts to be reduced from timing t31, at timing t32, it is determined that the reduction in the operation amount X has been started.

In FIG. 6(b), a change in the longitudinal acceleration Gx in a case where the limitation processing is not executed is indicated by a broken line. On the other hand, a change in the longitudinal acceleration Gx in the present embodiment in which the limitation processing is executed is indicated by a solid line.

When the reduction rate ΔX of the operation amount is equal to or larger than the second determination reduction rate ΔXth2 at timing t32, the limitation processing is started. In a case where the limitation processing is executed, the reduction rate of the braking force BP becomes smaller than that in the case where the limitation processing is not executed.

Immediately after the start of the limitation processing, the absolute value of the longitudinal acceleration Gx is large. Therefore, a relatively large value is set as the reduction rate instruction value dBP. As a result, the reduction rate of the braking force BP is relatively large. However, as the absolute value of the longitudinal acceleration Gx approaches 0 in accordance with the reduction in the operation amount X, the reduction rate instruction value dBP becomes smaller. Therefore, the reduction rate of the braking force BP gradually becomes smaller.

Even when the operation of the braking operation member 15 by the driver is canceled at timing t33, the instruction braking force BPTr is larger than the cancellation determination value BPth, and the braking force BP is still applied to the vehicle 10. Therefore, the limitation processing is continued even after timing t33. That is, even after timing t33, the reduction rate of the braking force BP is changed in accordance with the change in the longitudinal acceleration Gx.

Here, in a case where the operation amount X is reduced by the driver in a state where the longitudinal acceleration Gx is relatively small, if the deviation between the change in the longitudinal acceleration in accordance with the change in the operation amount X and the change in the actual longitudinal acceleration Gx is large, the driver may feel uncomfortable about the vehicle behavior.

In this regard, in the present embodiment, when the operation amount X is reduced in a state where the longitudinal acceleration Gx is relatively small, the reduction rate of the braking force BP is prevented from becoming too small even when the limitation processing is executed. That is, even when the limitation processing is executed, the deviation between the change in the longitudinal acceleration in accordance with the change of the operation amount X and the change in the actual longitudinal acceleration Gx is less likely to increase. Therefore, it is possible to prevent the driver from feeling uncomfortable about the vehicle behavior when the operation amount X is reduced.

When the longitudinal acceleration Gx increases due to the reduction in the operation amount X, the braking force BP is gradually reduced. Then, the change rate of the pitch angle of the vehicle body is reduced. As a result, it is possible to further prevent a decrease in the comfort of the passenger when the operation amount X of the braking operation member 15 by the driver is reduced.

### Fourth Embodiment

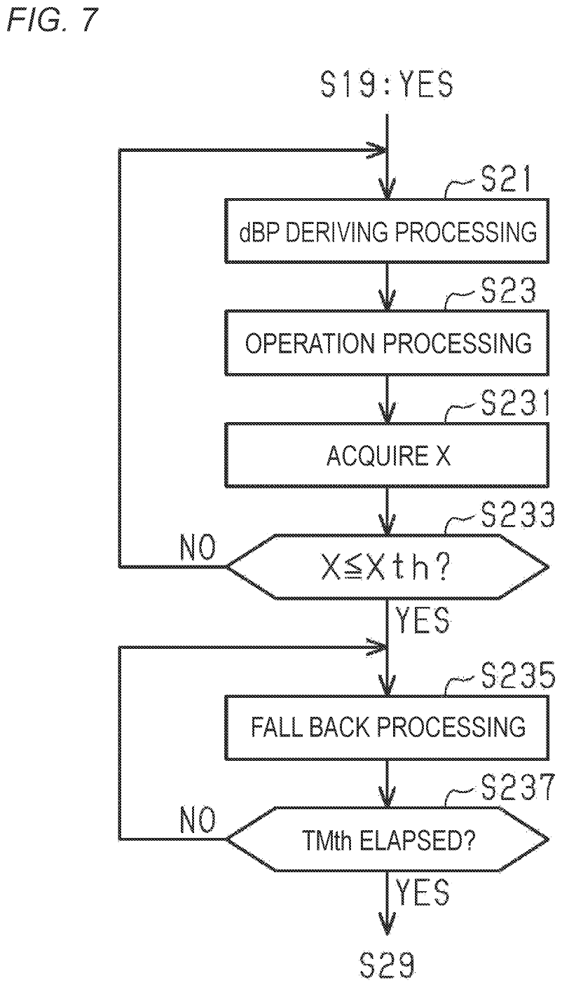

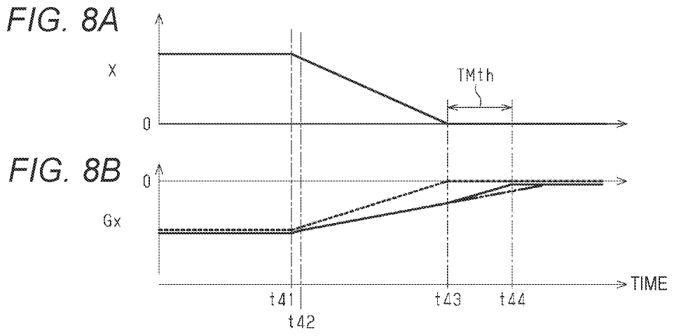

A fourth embodiment of a device for controlling braking of a vehicle will be described with reference to FIGS. 7 and 8. In the following description, portions different from those of the above-described embodiments will be mainly described, and the same reference signs will be given to the same or corresponding member configurations as those of the above-described embodiments, and redundant description will be omitted.

<Flow of Processing of Braking Control Device 40 when Operation of Braking Operation Member 15 by Driver is Canceled>

FIG. 7 illustrates a part of a processing routine executed by the braking control device 40 when the operation of the braking operation member 15 is canceled.

In the present processing routine, the braking control device 40 executes each processing of steps S11 to S19 illustrated in FIG. 2. In step S19, when the reduction rate ΔX is equal to or larger than the second determination reduction rate ΔXth2 (YES), the control unit 41 of the braking control device 40 executes the limitation processing.

In the limitation processing, in step S21, the control unit 41 executes the deriving processing of deriving the reduction rate instruction value dBP. Subsequently, in step S23, the control unit 41 executes operation processing. When the control unit 41 operates the braking device 20 through the execution of the limitation processing, the control unit 41 proceeds the processing to step S231.

In step S231, the control unit 41 acquires the operation amount X. In the next step S233, the control unit 41 determines whether or not the operation amount X acquired in step S233 is equal to or less than a determination operation amount Xth. The determination operation amount Xth is a criterion for determining whether or not the operation of the braking operation member 15 by the driver has been canceled. For example, 0 may be set as the determination operation amount Xth. When the operation amount X is equal to or less than the determination operation amount Xth, it is regarded that the operation has been canceled. On the other hand, when the operation amount X is larger than the determination operation amount Xth, it is not regarded that the operation has been canceled.

When the operation amount X is larger than the determination operation amount Xth (S233: NO), the control unit 41 proceeds the processing to step S21. That is, the control unit 41 continues the limitation processing. On the other hand, when the operation amount X is equal to or less than the determination operation amount Xth (S233: YES), the control unit 41 proceeds the processing to step S235. That is, the control unit 41 ends the limitation processing.

In step S235, the control unit 41 executes fall back processing. That is, when the operation of the braking operation member 15 by the driver is canceled during the execution of the limitation processing, the control unit 41 ends the limitation processing and executes the fall back processing. In the fall back processing, the control unit 41 makes the reduction rate of the braking force BP larger than that at the time of execution of the limitation processing.

For example, in the fall back processing, the control unit 41 operates the braking device 20 in such a manner that the braking force BP becomes 0 when a specified time TMth elapses from the start time point of the fall back processing. In this case, the control unit 41 derives a value obtained by dividing a criterion braking force BPa, which is the instruction braking force BPTr at the start time of the fall back processing, by the specified time TMth as the reduction rate instruction value dBP1. Note that a value less than 1 second is set as the specified time TMth. As an example, the specified time TMth is 500 milliseconds.

The control unit 41 derives the product of the reduction rate instruction value dBP1 and the cycle time as the instruction reduction amount ΔBP1. The cycle time is a time required from the previous execution of the processing of step S235 to the current execution. The control unit 41 derives a value obtained by subtracting the instruction reduction amount ΔBP1 from the instruction braking force BPTr as the latest instruction braking force BPTr. As a result, the instruction braking force BPTr can be reduced at a rate corresponding to the reduction rate instruction value dBP1. Then, the control unit 41 operates the braking device 20 on the basis of the latest instruction braking force BPTr. When the braking force BP is controlled through the execution of the fall back processing, the control unit 41 proceeds the processing to step S237.

In step S237, the control unit 41 determines whether or not the elapsed time from the start time of the fall back processing has reached the specified time TMth. When the elapsed time has not reached the specified time TMth, it is regarded that the braking force BP is still applied to the vehicle 10. On the other hand, when the elapsed time has reached the specified time TMth, it is regarded that the braking force BP is not applied to the vehicle 10. Therefore, when the elapsed time has not reached the specified time TMth (S237: NO), the control unit 41 proceeds the processing to step S235. That is, the control unit 41 continues the fall back processing. On the other hand, when the elapsed time has reached the specified time TMth (S237: YES), the control unit 41 proceeds the processing to step S29. That is, the control unit 41 ends the fall back processing.

### Operation and Effects of Present Embodiment

As illustrated in FIGS. 8(a) and 8(b), when the operation amount X starts to be reduced from timing t41, at timing t42, it is determined that the reduction in the operation amount X has been started.

In FIG. 8(b), a transition in the longitudinal acceleration Gx in a case where the limitation processing is not executed is indicated by a broken line. In addition, the transition of the longitudinal acceleration Gx in the present embodiment, in which the limitation processing and the fall back processing are executed, is indicated by a solid line. Further, the transition of the longitudinal acceleration Gx in a case where the limitation processing is executed but the fall back processing is not executed is indicated by a two-dot chain line.

When the reduction rate ΔX of the operation amount is equal to or larger than the second determination reduction rate ΔXth2 at timing t42, the limitation processing is started. In a case where the limitation processing is executed, the reduction rate of the braking force BP becomes smaller than that in the case where the limitation processing is not executed.

At timing t43 during the execution of the limitation processing, the operation amount X becomes equal to or less than the determination operation amount Xth, and it is determined that the operation of the braking operation member 15 by the driver is canceled. In the present embodiment, the limitation processing is ended at timing t43, and the fall back processing is started. Then, the reduction rate of the braking force BP becomes larger than that during the execution of the limitation processing. That is, the braking force BP is not applied to the vehicle 10 at timing t44 after the lapse of the specified time TMth from timing t43. As a result, the increase rate of the longitudinal acceleration Gx becomes larger during the execution of the fall back processing than during the execution of the limitation processing.

Incidentally, even when it is determined that the operation of the braking operation member 15 by the driver has been canceled, the braking force BP is still applied to the vehicle 10 even at timing t44 in a case where the processing does not proceed from the limitation processing to the fall back processing.

When the driver cancels the operation of the braking operation member 15, the driver may start the operation of the accelerator pedal. When the braking force BP at the time when the operation of the accelerator pedal has been started is large, the vehicle 10 is less likely to accelerate. In this case, the driver may feel discomfort with the vehicle behavior of difficulty in accelerating.

In this regard, in the present embodiment, when the operation of the braking operation member 15 by the driver is canceled, the reduction rate of the braking force BP is increased. As a result, when the operation of the accelerator pedal has been started by the driver immediately after the cancellation of the operation of the braking operation member 15 by the driver, an event that the vehicle 10 is difficult to accelerate hardly occurs. Therefore, in the present embodiment, it is possible to achieve both of the state that the passenger is less likely to feel uncomfortable and the state that the driver is less likely to feel uncomfortable about the vehicle behavior.

### Fifth Embodiment

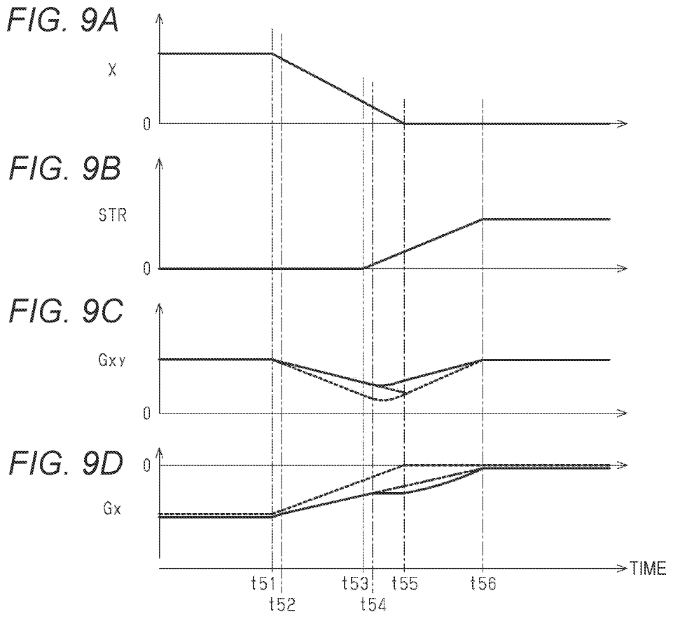

A fifth embodiment of a device for controlling braking of a vehicle will be described with reference to FIGS. 9 to 13. In the following description, portions different from those of the above-described embodiments will be mainly described, and the same reference signs will be given to the same or corresponding member configurations as those of the above-described embodiments, and redundant description will be omitted.

In the present embodiment, the content of the processing in step S21 in FIG. 2 is different from those of the above-described embodiments. That is, in step S21, the control unit 41 derives the reduction rate instruction value dBP in consideration of the following points.
Whether or not the operation of the braking operation member 15 by the driver has been canceled.
Whether or not it is determined by the steering determination unit 43 that the driver has started steering.

For example, the reduction rate instruction value dBP when the operation of the braking operation member 15 is not canceled and it is not determined that the driver has started steering is set as a criterion reduction rate instruction value dBP11. At this time, upon determining that the driver has started steering under a situation where the operation of the braking operation member 15 is not canceled, the control unit 41 sets a value smaller than the criterion reduction rate instruction value dBP11 as the reduction rate instruction value dBP. For example, the control unit 41 sets 0 as the reduction rate instruction value dBP. Thereafter, when the operation of the braking operation member 15 by the driver is canceled, the control unit 41 gradually increases the reduction rate instruction value dBP.

When the reduction rate instruction value dBP is increased after the cancellation of the operation of the braking operation member 15, the control unit 41 preferably increases the reduction rate instruction value dBP in consideration of the longitudinal acceleration Gx and the lateral acceleration Gy. For example, the control unit 41 derives a total acceleration Gxy on the basis of the longitudinal acceleration Gx and the lateral acceleration Gy, and derives a larger value as the total acceleration Gxy increases, as the reduction rate instruction value dBP.

Note that the control unit 41 can derive the total acceleration Gxy by using the following relational expression (Formula 1).

[Mathematical Formula 1]

Gxy=\sqrt{Gx²+Gy²} (Formula 1)

Upon deriving the reduction rate instruction value dBP, the control unit 41 executes the operation processing in step S23. When the instruction braking force BPTr is equal to or less than the cancellation determination value BPth in step S27 (YES), the control unit 41 ends the limitation processing.

Here, the steering determination unit 43 may determine whether or not steering has been started by the driver on the basis of a change in the steering angle STR. For example, the steering determination unit 43 derives an absolute value of a value obtained by time-differentiating the steering angle STR as a steering speed dSTR. Then, when the steering speed dSTR is equal to or larger than a determination steering speed dSTRth, the steering determination unit 43 determines that steering has been started. On the other hand, when the steering speed dSTR is less than the determination steering speed dSTRth, the steering determination unit 43 does not determine that steering has been started.

### Operation and Effects of Present Embodiment

FIG. 9 illustrates changes in the operation amount X, the steering angle STR, the total acceleration Gxy, and the longitudinal acceleration Gx when the operation of the braking operation member 15 by the driver is canceled.

As illustrated in FIGS. 9(a), 9(b), 9(c), and 9(d), when the braking force is applied to the vehicle 10 by the operation of the braking operation member 15 by the driver, the vehicle 10 decelerates.

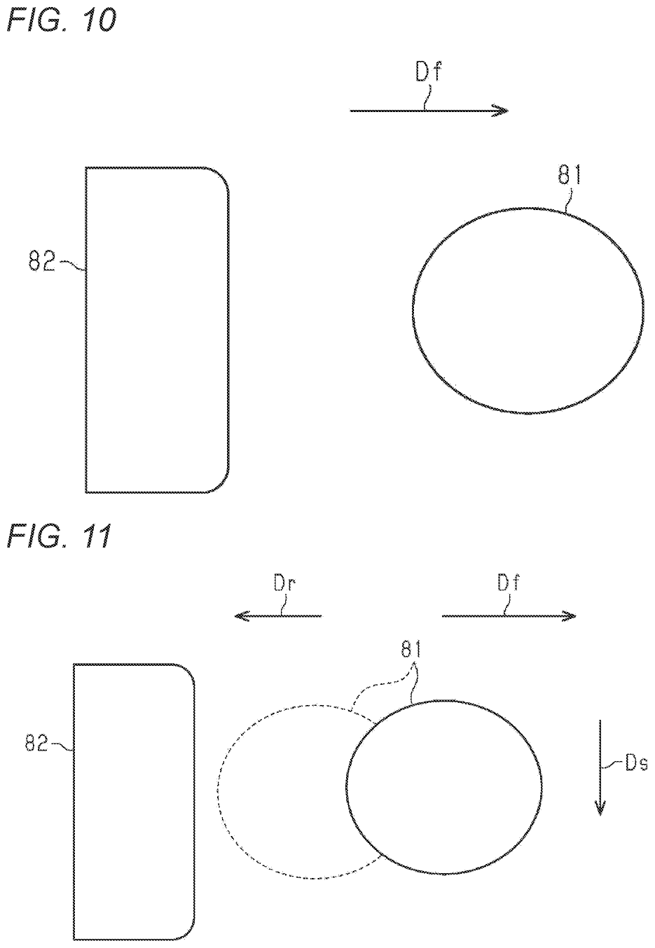

FIG. 10 schematically illustrates a positional relationship between the head 81 of the passenger and a headrest 82 at timing t51 in FIG. 9. At timing t51, the vehicle 10 is decelerated. Therefore, the head 81 of the passenger is separated from the headrest 82 to a front side Df by the inertial force due to the deceleration.

In the example shown in FIG. 9, the operation amount X of the braking operation member 15 starts to be reduced from timing t51. Then, when the reduction rate ΔX of the operation amount is equal to or larger than the second determination reduction rate ΔXth2 at timing t52, the limitation processing is started. In FIG. 9(d), a transition in the longitudinal acceleration Gx in a case where the limitation processing is not executed is indicated by a broken line. That is, in a case where the limitation processing is executed, the reduction rate of the braking force BP becomes smaller than that in the case where the limitation processing is not executed.

FIG. 11 schematically illustrates a positional relationship between the head 81 of the passenger and the headrest 82 in a period from timing t52 to timing t53. In FIG. 11, a broken line indicates the position of the head 81 in a case where the limitation processing is not executed. A solid line indicates the position of the head 81 when the limitation processing is executed. As illustrated in FIGS. 10 and 11, when the limitation processing is not executed, the longitudinal acceleration Gx suddenly increases, and thus, the inertial force due to the deceleration of the vehicle 10 is suddenly reduced. As a result, the head 81 is displaced to a rear side Dr that is the opposite direction of the front side Df. On the other hand, when the limitation processing is started, the longitudinal acceleration Gx increases, but the increase rate of the longitudinal acceleration Gx is smaller than that in the case where the limitation processing is not executed. In this case, although the inertial force due to the deceleration of the vehicle 10 is reduced, the reduction rate of the inertial force is small. Therefore, the movement of the head 81 to the rear side Dr is reduced as compared with the case where the limitation processing is not started.

In the example illustrated in FIG. 9, the vehicle 10 is traveling at timing t53. Then, the driver starts steering from timing t53. That is, the steering angle STR gradually increases. Then, it is determined that steering has been started at the subsequent timing t54. In this case, since the reduction rate instruction value dBP is changed, the reduction rate of the braking force BP becomes smaller than before timing t54. For example, the braking force BP is held from timing t54.

In FIG. 9(d), the transition of the longitudinal acceleration Gx in the case of the present embodiment is indicated by a solid line. The transition of the longitudinal acceleration Gx in a case where the limitation processing is executed but the reduction rate instruction value dBP is not changed depending on the presence or absence of steering is indicated by a two-dot chain line.

FIG. 9(c) illustrates a change in the total acceleration Gxy. In FIG. 9(c), a change in the total acceleration Gxy in a case where the limitation processing is not executed is indicated by a broken line. In addition, a change in the total acceleration Gxy in the case of the present embodiment is indicated by a solid line. The transition of the absolute value of the total acceleration Gxy in a case where the limitation processing is executed but the reduction rate instruction value dBP is not changed depending on the presence or absence of steering is indicated by a two-dot chain line.

When the limitation processing is not executed, the reduction rate of the longitudinal acceleration Gx is relatively large. Therefore, the total acceleration Gxy is reduced. When it is determined that steering has been started at timing t54, the lateral acceleration Gy increases. On the other hand, the longitudinal acceleration Gx is reduced. Therefore, after timing t54, the total acceleration Gxy gradually increases. Even when the longitudinal acceleration Gx becomes 0 at timing t55, the steering angle STR increases. Then, the steering angle STR is held at timing t56. Therefore, the total acceleration Gxy is held after timing t56.

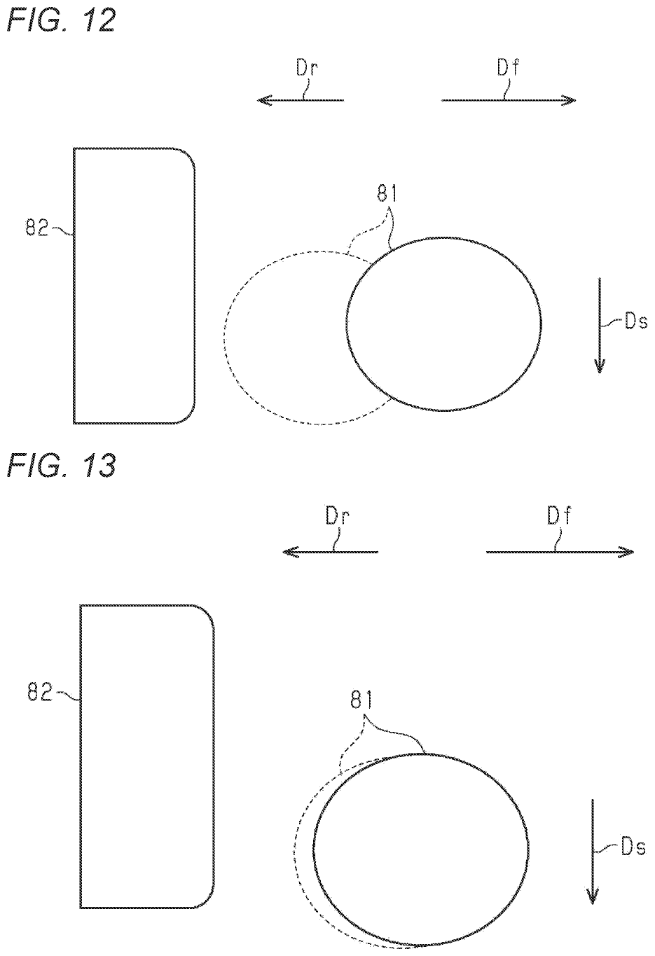

In a case where the total acceleration Gxy changes in this manner, when the lateral acceleration Gy increases due to the start of steering, the head 81 of the passenger is relatively largely displaced in a lateral direction Ds as indicated by the broken lines in FIGS. 11 and 12. Then, at timing t56 when the steering angle STR is held, the head 81 is displaced to the front side Df again as indicated by the broken lines in FIGS. 12 and 13. When the limitation processing is not executed in this manner, the head 81 is relatively largely displaced to the rear side Dr, and thereafter, the head 81 is relatively largely displaced in the lateral direction Ds. Furthermore, thereafter, the head 81 is displaced relatively largely to the front side Df.

In contrast, in the present embodiment, the limitation processing is executed. Furthermore, when steering is started during the execution of the limitation processing, a period for holding the braking force BP is provided. Then, when the operation of the braking operation member 15 is canceled, the period ends. After the elapse of the period, the reduction rate of the braking force BP is increased more than during the period. More specifically, as the total acceleration Gxy is reduced, the reduction rate of the braking force BP is increased.

As a result, the total acceleration Gxy shifts as indicated by a solid line in FIG. 9(c). That is, the change amount of the total acceleration Gxy is smaller than that in the case where the limitation processing is not executed.

As a result, as illustrated in FIGS. 11 and 12, even when the head 81 is displaced in the lateral direction Ds due to the increase in the lateral acceleration Gy, the amount of displacement of the head 81 in the lateral direction Ds can be reduced. In addition, since the head 81 is prevented from being displaced to the rear side Dr by the execution of the limitation processing (see FIG. 11), the subsequent displacement of the head 81 to the front side Df is less likely to occur. That is, displacement of the head 81 of the passenger can be reduced. As a result, it is possible to prevent the passenger from feeling uncomfortable.

### Modified Examples

Each of the above embodiments can be modified as follows. The above embodiments and the following modification examples can be implemented in combination with each other within a range not technically contradictory.
In the fifth embodiment, as the reduction rate instruction value dBP at the start of the limitation processing, a smaller value may be set as the vehicle body speed VS at the start is smaller.
In the fifth embodiment, before the determination that steering has been started, the reduction rate instruction value dBP may be reduced as the longitudinal acceleration Gx is increased.
In the fifth embodiment, when it is determined that the steering has been started during the execution of the limitation processing, the reduction rate of the braking force BP is made smaller than that before the determination. However, the vehicle braking control device disclosed here is not limited thereto. The vehicle 10 is provided with the monitoring system 50 and a navigation device that monitor the surroundings of the vehicle 10. Therefore, it is possible to predict whether or not steering is started by the driver by analyzing the information obtained by the monitoring system 50 and the navigation device. For example, when the vehicle 10 is traveling in front of a curve, it can be predicted that the driver starts steering. In addition, in a case where movement of the vehicle 10 in a direction in which the driver desires to turn is permitted by a signal or the like under a situation where the driver operates a direction indicator, it can be predicted that the driver starts steering.

Therefore, during the execution of the limitation processing, it is preferable to cause the steering determination unit 43 to determine whether or not it can be predicted that steering is started by the driver. Then, in a case where it is determined that the steering can be predicted to be started, the reduction rate of the braking force BP may be made smaller than that before the determination is made from the timing before the steering is actually started. In this case, the braking force BP may be held. Thereafter, the period in which the reduction rate is reduced may be ended by, for example, canceling the operation of the braking operation member 15, and the reduction rate of the braking force BP may be gradually increased.
In the fifth embodiment, it is an example to provide a period for holding the braking force BP when it is determined that steering has been started or it is determined that steering can be predicted to start during the execution of the limitation processing. For example, when it is determined that steering has been started or it is determined that steering can be predicted to be started, when a period in which the reduction rate of the braking force BP is made smaller than that before the determination is made is provided, the braking force BP may be reduced even in the period.

Further, the above period may be ended at a timing different from the timing at which the operation of the braking operation member 15 by the driver is canceled. For example, the period may be ended at a timing when the total acceleration Gxy is reduced from the peak value by a predetermined amount.

In addition, a period until a predetermined time elapses from the time point at which it is determined that steering has been started may be set as the above period.
The steering determination unit 43 may determine whether or not steering has been started without using the steering speed dSTR. For example, when the change amount of the steering angle STR from the steering angle STR at the time when steering is not started becomes equal to or larger than a threshold value, the steering determination unit 43 may determine that steering has been started.
The fall back processing may have contents different from the contents described in the fourth embodiment as long as the reduction rate of the braking force BP can be made larger than that during the execution of the limitation processing. For example, the product of the reduction rate instruction value dBP and the correction gain for the fall back during the execution of the limitation processing may be set as the reduction rate instruction value dBP during the execution of the fall back processing, and the braking force BP may be reduced in accordance with the reduction rate instruction value dBP.
In the fourth embodiment and the third embodiment, as the reduction rate instruction value dBP at the start of the limitation processing, a smaller value may be set as the vehicle body speed VS at the start is smaller.
In the fourth embodiment, before the operation of the braking operation member 15 is canceled, the reduction rate instruction value dBP may be reduced as the longitudinal acceleration Gx is increased by the limitation processing.
In the third embodiment, the reduction rate instruction value dBP is varied in accordance with the change in the longitudinal acceleration Gx during the execution of the limitation processing, but the vehicle braking control device disclosed here is not limited thereto. For example, in the limitation processing, the reduction rate instruction value dBP may be held at a value corresponding to the longitudinal acceleration Gx at the start of the limitation processing.
In the second embodiment, the reduction rate instruction value dBP may be varied depending on whether the vehicle 10 is traveling or the vehicle 10 is stopped at the start of the limitation processing. In this case, the reduction rate instruction value dBP in a case where the vehicle 10 is traveling at the start time of the limitation processing may be made larger than the reduction rate instruction value dBP in a case where the vehicle 10 is stopped at the start time of the limitation processing.
In the deriving processing in step S21 illustrated in FIG. 2, the product of the reduction rate of the required braking force BPr at that time and the predetermined gain may be derived as the reduction rate instruction value dBP. In this case, a positive value less than 1 may be set as the predetermined gain.
The braking determination unit 42 may determine whether or not the reduction in the operation amount X has been started without using the reduction rate ΔX of the operation amount X. For example, when the reduction amount from the operation amount X before the reduction in the operation amount X is started becomes equal to or larger than the threshold value, the braking determination unit 42 may determine that the reduction in the operation amount X has been started.
In each of the above embodiments, the vehicle 10 may be a vehicle that can generate regenerative braking force in addition to friction braking force, which is the braking force generated due to the operation of the braking mechanism 12. In this case, the control unit 41 controls the sum of the friction braking force and the regenerative braking force.
The braking mechanism 12 may be an electric brake that can control the force of pressing the friction material 123 against the rotating body 122 without using any brake fluid.
In each of the above embodiments, the braking control device 40 is not limited to a device that includes a CPU and a memory that stores a program and executes software processing. That is, the braking control device 40 may have any of the following configurations (a) to (c). (a) The braking control device 40 includes one or more processors that execute various processing according to a computer program. The processor includes a CPU and memories such as a RAM and a ROM. The memory stores a program code or a command configured to cause the CPU to execute processing. The memory, that is, a computer-readable medium, includes any available medium that can be accessed by a general-purpose or dedicated computer. (b) The braking control device 40 includes one or more dedicated hardware circuits that execute various processing. Examples of the dedicated hardware circuit include an application-specific integrated circuit, that is, an ASIC or an FPGA. The ASIC is an abbreviation of “application specific integrated circuit”, and the FPGA is an abbreviation of “field programmable gate array”. (c) The braking control device 40 includes a processor that executes a part of various processing according to a computer program and a dedicated hardware circuit that executes the remaining processing among the various processing.

1. A device for controlling braking of a vehicle that controls a braking force against the vehicle due to an operation of a braking device, the device comprising:
a control unit that controls a braking force against the vehicle in accordance with an operation amount of a braking operation member; and
a braking determination unit that determines whether or not a reduction in the operation amount has been started when a braking force is applied to the vehicle due to an operation of the braking operation member, wherein
in a case where a reduction rate of the operation amount upon determination that the reduction in the operation amount has been started is equal to or larger than a reduction rate determination value, the control unit starts limitation processing of limiting a reduction rate of the braking force against the vehicle.

2. The device for controlling braking of a vehicle according to claim 1, wherein
in the limitation processing, the control unit reduces the reduction rate of the braking force against the vehicle as a vehicle body speed of the vehicle upon determination that the reduction in the operation amount has been started is smaller.

3. The device for controlling braking of a vehicle according to claim 2, wherein
in the limitation processing, the control unit reduces the reduction rate of the braking force against the vehicle as longitudinal acceleration of the vehicle increases.

4. The device for controlling braking of a vehicle according to claim 3, wherein
when the operation of the braking operation member is canceled during execution of the limitation processing, the control unit ends the limitation processing and executes fall back processing of making the reduction rate of the braking force against the vehicle larger than that at the time of execution of the limitation processing.

5. The device for controlling braking of a vehicle according to claim 4, further comprising
a steering determination unit that determines whether steering has been started or whether steering has been predicted to be started, wherein
in the limitation processing, when it is determined that steering has been started or it is determined that steering has been predicted to be started, the control unit sets a period in which the reduction rate of the braking force against the vehicle is made smaller than that before the determination is made, and after a lapse of the period, the control unit makes the reduction rate of the braking force against the vehicle larger than that during the period.

6. The device for controlling braking of a vehicle according to claim 3, further comprising
a steering determination unit that determines whether steering has been started or whether steering has been predicted to be started, wherein
in the limitation processing, when it is determined that steering has been started or it is determined that steering has been predicted to be started, the control unit sets a period in which the reduction rate of the braking force against the vehicle is made smaller than that before the determination is made, and after a lapse of the period, the control unit makes the reduction rate of the braking force against the vehicle larger than that during the period.

7. The device for controlling braking of a vehicle according to claim 2, further comprising
a steering determination unit that determines whether steering has been started or whether steering has been predicted to be started, wherein
in the limitation processing, when it is determined that steering has been started or it is determined that steering has been predicted to be started, the control unit sets a period in which the reduction rate of the braking force against the vehicle is made smaller than that before the determination is made, and after a lapse of the period, the control unit makes the reduction rate of the braking force against the vehicle larger than that during the period.

8. The device for controlling braking of a vehicle according to claim 2, wherein
when the operation of the braking operation member is canceled during execution of the limitation processing, the control unit ends the limitation processing and executes fall back processing of making the reduction rate of the braking force against the vehicle larger than that at the time of execution of the limitation processing.

9. The device for controlling braking of a vehicle according to claim 1, wherein
in the limitation processing, the control unit reduces the reduction rate of the braking force against the vehicle as longitudinal acceleration of the vehicle increases.

10. The device for controlling braking of a vehicle according to claim 9, wherein
when the operation of the braking operation member is canceled during execution of the limitation processing, the control unit ends the limitation processing and executes fall back processing of making the reduction rate of the braking force against the vehicle larger than that at the time of execution of the limitation processing.

11. The device for controlling braking of a vehicle according to claim 10, further comprising
a steering determination unit that determines whether steering has been started or whether steering has been predicted to be started, wherein
in the limitation processing, when it is determined that steering has been started or it is determined that steering has been predicted to be started, the control unit sets a period in which the reduction rate of the braking force against the vehicle is made smaller than that before the determination is made, and after a lapse of the period, the control unit makes the reduction rate of the braking force against the vehicle larger than that during the period.

12. The device for controlling braking of a vehicle according to claim 2, wherein
when the operation of the braking operation member is canceled during execution of the limitation processing, the control unit ends the limitation processing and executes fall back processing of making the reduction rate of the braking force against the vehicle larger than that at the time of execution of the limitation processing.

13. The device for controlling braking of a vehicle according to claim 12, further comprising
a steering determination unit that determines whether steering has been started or whether steering has been predicted to be started, wherein
in the limitation processing, when it is determined that steering has been started or it is determined that steering has been predicted to be started, the control unit sets a period in which the reduction rate of the braking force against the vehicle is made smaller than that before the determination is made, and after a lapse of the period, the control unit makes the reduction rate of the braking force against the vehicle larger than that during the period.

14. The device for controlling braking of a vehicle according to claim 1, further comprising
a steering determination unit that determines whether steering has been started or whether steering has been predicted to be started, wherein
in the limitation processing, when it is determined that steering has been started or it is determined that steering has been predicted to be started, the control unit sets a period in which the reduction rate of the braking force against the vehicle is made smaller than that before the determination is made, and after a lapse of the period, the control unit makes the reduction rate of the braking force against the vehicle larger than that during the period.
